(19) United States
(12) Patent Application Publication
(10) Pub. No.: US 2009/0006254 A1
(43) Pub. Date: Jan. 1, 2009

(54) VIRTUAL PREPAID OR CREDIT CARD AND PROCESS AND SYSTEM FOR PROVIDING SAME AND FOR ELECTRONIC PAYMENTS

(75) Inventors: Marc Mumm, Munchen (DE); Rajasekharan Kuppuswamy, Munchen (DE)

Correspondence Address: VOLPE AND KOENIG, P.C., UNITED PLAZA, SUITE 1600, 30 SOUTH 17TH STREET, PHILADELPHIA, PA, 19103, US

(73) Assignee: VOICE.TRUST AG, Munchen (DE)

(21) Appl. No.: 11/970,088

(22) Filed: Jan. 7, 2008

(30) Foreign Application Priority Data
Jun. 29, 2007 (DE) 102007030114.8
Oct. 12, 2007 (DE) 102007048976.7

(51) Int. Cl. G06Q 20/00

(52) U.S. Cl. 705/44

(57) ABSTRACT

A virtual credit card, as a set of data, free of a physical substrate, the data being adapted to authorize a person who is in possession thereof to pay for a product or service, in particular in the framework of an online transaction, the data set being produced on the basis of a credit card account or a pre-payment and in response to a user authentication procedure involving an evaluation of biometric features of a user, in particular of his/her voice profile, and being available at a telecommunication terminal, in particular a mobile phone, of the authenticated user.

### BACKGROUND

This invention relates to a virtual credit card (i.e. a set of data containing all relevant information of a physical credit card, e.g. credit card number, expiration date, second security code=CVV2 . . . and having the function thereof, at least to a predetermined extent) and to a process and system for providing such virtual credit card, as well as to an electronic payment process and system.

Although nowadays credit cards are widely spread and used in the internet, many concerns, restrictions and open issues are linked to the usage.

The growing number of credit card fraud, phishing and pharming attacks limits the willingness of customers to use credit cards both online and offline. More and more users are not willing to enter their credit card information on websites as they are afraid of becoming victims of ID and credit card fraud. Thieves would have immediate access to their credit card account, whereas the fraud is limited by the credit limit of the card.

Besides online fraud, happening after having entered credit card details online, additionally, cards can get lost, get stolen or any other kind of fraud can happen. This is a general disadvantage of any kind of physical card, known since long ago, but not yet satisfactory resolved.

Additionally, the growing number of teenagers using the internet for shopping is not yet fully served. Teens are typically the most Internet-conversant segment of the population, but they are limited in their desire to shop online as the primary means of payment used on the Internet is credit cards and teenagers below a certain age or income have only restricted access to credit cards.

In the last few years, therefore, several schemes for generating and using online-based derivatives of regular credit cards have been published and, at least to some extent, introduced in internet payment procedures. However, although these attempts provide a number of advantages and look promising, they suffer from several problems regarding the complexity of required procedures and/or the fulfilment of security requirements.

### SUMMARY

Therefore, it is an object of the present invention to provide an improved virtual credit card and process, and a system for providing same and for electronic payments, which in particular are flexible and easy to handle and, nevertheless, make possible the high security standards which are required for financial transactions in general, and specifically for the distribution and usage of credit cards.

This object is, in its product aspect, solved by a virtual credit card according to the invention, and in its process aspect by a process according to the invention, and in its system aspect by a system according to the invention.

The virtual prepaid/credit card is a virtual credit card (containing all relevant information of a credit card, e.g. credit card number, expiration date, second security code (CVV2), . . . ) sent to the user via SMS directly on his/her mobile phone—as illustrated in FIG. 1—and therefore usable from everywhere around the world, at any time without the need of having a physical plastic card with you.

The virtual prepaid/credit card gives the user the opportunity to act more flexible, safer and more convenient than with a physical credit card without the need to carry cash with you. Besides, the consumer can use a virtual card for additional purposes e.g. giving away virtual gift cards or enabling usage by other people (children, friends, . . . ) in an easy way.

Once registered on a dedicated website, the user isn't dependent on the physical credit card any more. The solution can be web-based or mobile-based. This means that the solution can be used via a web interface or directly from the mobile phone. For the mobile-based solution, no access to internet is necessary. The procedure can be executed completely via the mobile phone using voice authentication. In the web-based scenario voice authentication is replaced with a secure login using a user-ID or user name, combined with a password or PIN code. For both alternatives, the user will receive a virtual card on his mobile phone via SMS. This virtual card (either prepaid or credit) is usable in the same way as any other credit card in any online shop.

The invention also provides a platform for financial transactions between private users of the system (peer-to-peer), as well as for the access to cash, using cash dispensers which are adapted to the system.

One embodiment of the invention provides for some kind of system-internal currency which may be designated as “e-credit” and which may be managed with system-internal accounts of the respective users (card holders). It may be useful to link these system-internal accounts to a general account of the system, which makes the system relatively independent from external credit card or banking systems and enables a flexible coupling to such systems. The system may be used by enrolled (and authenticated) users in its full performance. Furthermore, it is open to non-enrolled users, as recipients of electronic money or even cash. In a preferred embodiment which is excellent due to its extremely low safety risks, anybody who participates in the final transaction as a sender of money has to make a payment of a sufficient amount their own system-internal account, and the predetermined amount likewise limits any transaction amounts which may be handled by the holder of the virtual credit or prepaid card.

Further important aspects of the invention are described below.

It is to be noted that any terminal having a connection to a telecommunication network is suitable as telecommunications terminal for producing the virtual credit or prepaid card, e.g. in addition to mobile phones or other mobile terminals (e.g. Blackberry, PDA or notebook with mobile transceiver part, etc.) fixed-line phones, satellite phones etc., or even data terminals comprising a suitable equipment, e.g. for VoIP transmission.

Regarding the enrollment or authentication procedures, respectively, it is to be noted that they are preferably based on a voice profile of the user. Besides this, further biometric features are to be considered in general, as well as PINs, code words or “secret” information originating from the private surroundings of the users (so-called “shared secrets”) which have been registered in the system in advance. When implementing the system, it may be useful to offer the user, in case of failure of an enrollment or authentication, a second way, on the basis of a corresponding user menu, which second way allows for an at least temporary usage of the system without regular enrollment/authentication. Such multi-step authentication solutions are, as such, described in further patent applications of the applicant and will, therefore, not be explained in detail here.

### BRIEF DESCRIPTION OF THE DRAWINGS

Further advantages and aspects of the invention may be derived from the following explanation of preferred embodiments in connection with the figures, of which:

FIG. 1 shows a screen of a mobile phone display illustrating important aspects of the virtual credit card of an embodiment of the invention,

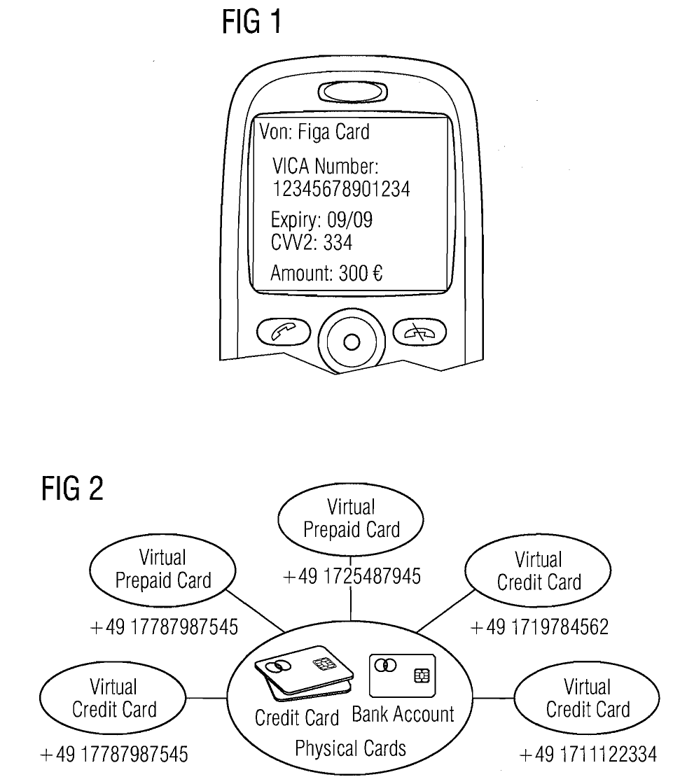

FIG. 2 shows a diagram illustrating a basic scheme of creating virtual prepaid/credit cards,

FIG. 3 shows a simplified default flow diagram further illustrating an embodiment of the invention, in the registration and enrollment phase,

FIG. 4 shows a default flow diagram of this embodiment, illustrating the usage of this service,

FIG. 5 shows an exemplary dialogue during the enrollment in the corresponding system,

FIG. 6 shows a corresponding dialogue of a verification during the usage of the system, and

FIG. 7 and 8 show modified dialogs during an enrollment or verification.

### DETAILED DESCRIPTION OF THE PREFERRED EMBODIMENTS

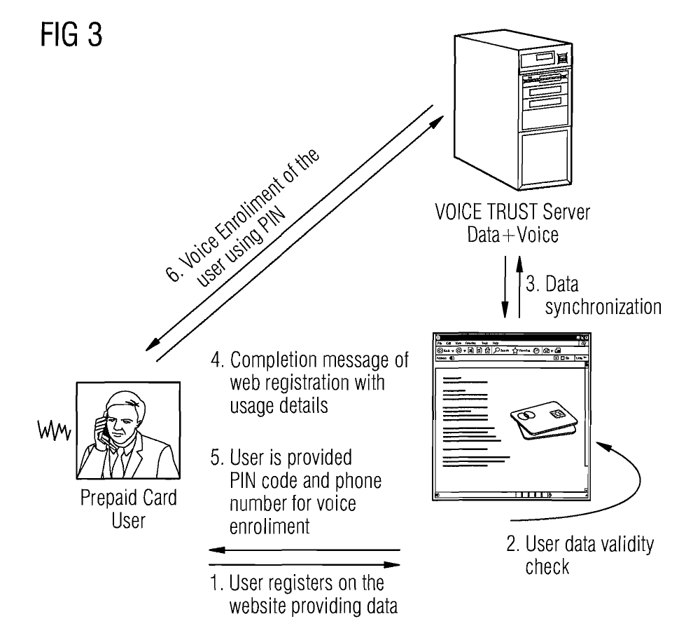

The system is based on the multi-tenant idea—it is comparable to the software field, where a single instance of the software runs on a software-as-a-service (SaaS) vendor's servers, serving multiple client organizations (tenants). In the case of a virtual card the single instance of the software is the data of the original physical card or bank account, the tenants are the virtual credit or debit cards activated by the user, respectively the mobile phones, the virtual credit/prepaid card is sent to as illustrated in FIG. 2.

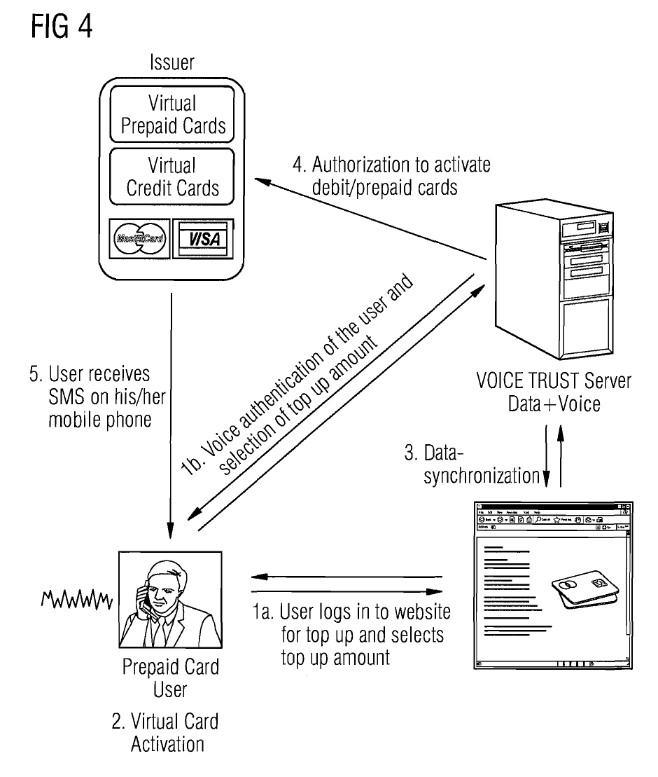

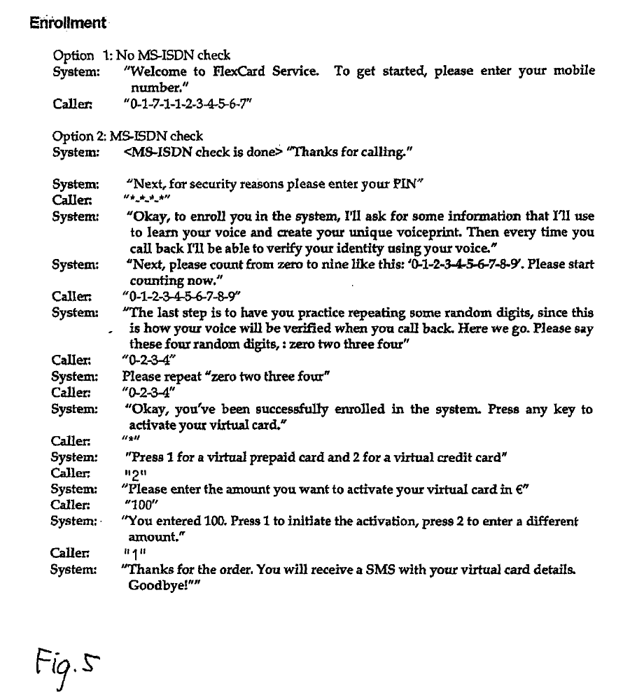

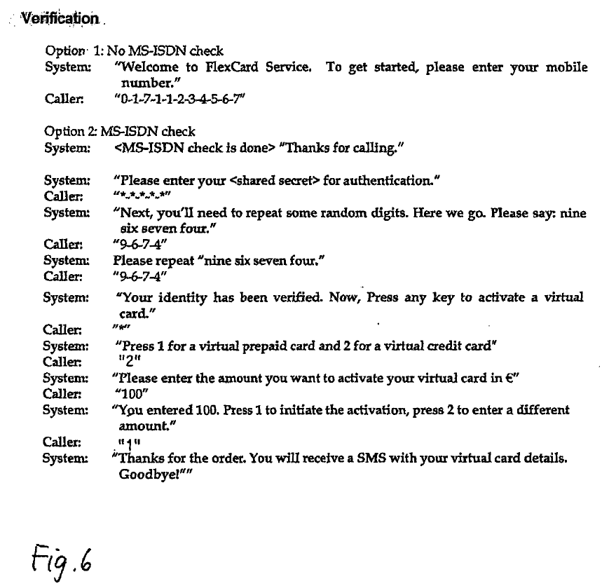

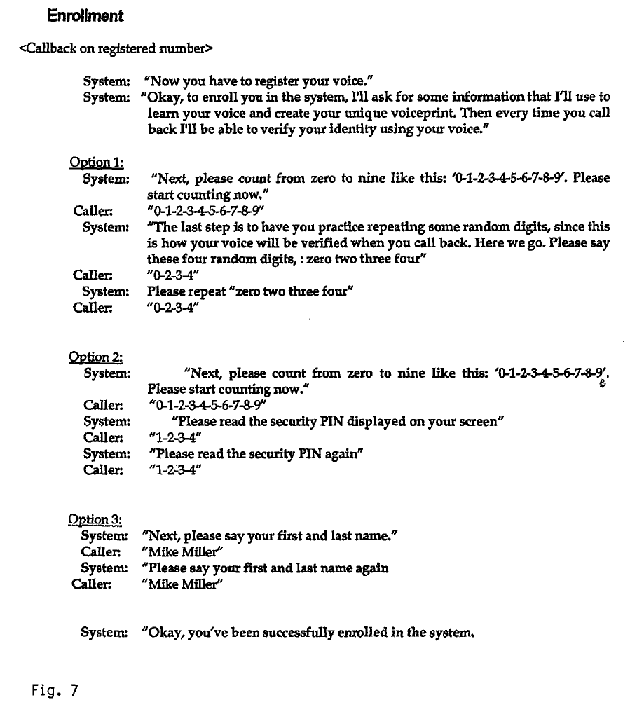

The default flow diagrams of FIG. 3 and 4 show the flow of web registration and voice enrollment (FIG. 3) and the usage of the service (FIG. 4). See also FIGS. 5 to 8 for more details about the enrollment and verification process.

For using the virtual prepaid/credit card, the user has to register on a dedicated website. During the registration, the user has to provide various data. The web registration is obligatory for all users who want to use the service. Voice registration/authentication is an additional feature, which enables users to use the service from the mobile phone. With regard to details of the voice authentication procedures and systems which are usable in the framework of the present invention, we refer to EP 1 172 770 B1 or EP 1 172 771 B1, as well as to several unpublished German patent applications of the applicant.

Web Registration:

The following data have to be provided by the users to register for the virtual prepaid/credit card. Part of the data (username, password, phone number, . . . ) will be used later on to identify and verify the user, part of the data (bank account or credit card details) is necessary to clear the money.
→Login Data: Username and Password
→Personal Date: Name, address, date of birth
→Default Cell phone number
→Bank Details: Bank account details and/or credit card details

Option:

The user can choose which reload method he is willing to use. The user can either choose a virtual prepaid card or a virtual credit card. A virtual prepaid card means that the amount of the virtual card is pre-paid. The amount is only usable once the money is cleared. Optionally the user can choose a normal virtual credit card. This means that the virtual credit card has the same characteristics as a normal credit card and the user does not have to pay in advance.

Voice Registration

After a successful first registration step the user will receive a SMS sent to his/her cell phone with a PIN and a phone number to complete the voice enrollment for using the service directly from the mobile phone and not web-based. This guarantees that the user can enroll for the voice service whenever he/she wants to do so.

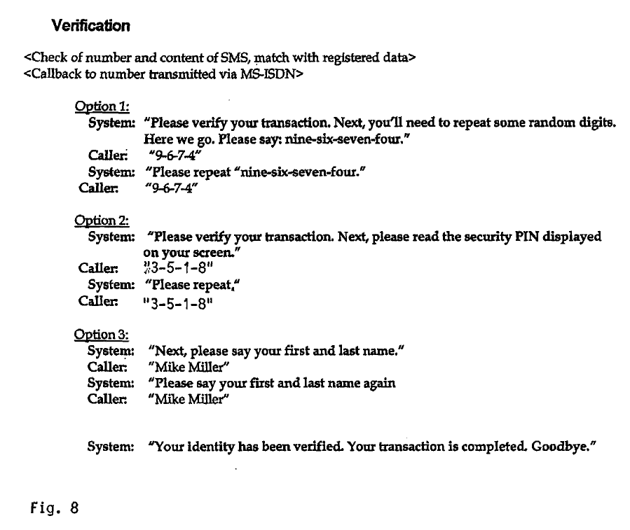

A detailed enrollment procedure is shown in FIG. 5 or—in a modified form—in FIG. 7, respectively.

Adding Additional Cell Phone Numbers

The user always registers with one default number. The mobile phone linked with this number will serve as the virtual card vehicle, on which the user will receive the virtual details SMS. With the default number the user also executes the voice enrollment. In cases of adding new, additional number for enable children, wives/husbands or other people there are different options:

Option 1:

After adding a new mobile phone number the system will send a SMS with a confirmation code to the default user's mobile phone number to confirm that the new number is added correctly and no fraud can happen.

Option 2:

For confirmation purposes the user receives an E-Mail on his/her default E-Mail account with an activation code to enable new mobile phone numbers. After clicking on the code the user will be redirected to an website to activate the new mobile phone number.

Option 3:

New numbers can be added to the existing and registered default number without the need to verify a new number. The can be either added and stored on the website and the user's account or have to be typed in every time the users wants to activate a virtual card.

Option 4:

The additional mobile phone number has to be entered every time the user wants to send the virtual card to a different mobile number.

An explanation of the usage or virtual card activation procedure, respectively, is given below, considering the two basic scenarios of web-based or mobile phone-based scenarios.

Web-Based Scenario

To activate a new virtual card online the user has to login to his/her account online. Having logged in to his/her account, the user can activate a new virtual card based on the stored data of the physical credit card or the bank account. Optionally, the user can choose whether he/she wants to activate a virtual prepaid card or a virtual credit card. This may depend on the payment method chosen as well as on the preferences of the user.

As a next step the user has to choose with which amount he/she wants to top up the prepaid card, respectively for which amount he/she wants to activate the credit card for. Optionally, the user can choose the expiration date of the credit/prepaid card.

The user has to choose whether he/she wants to send the virtual card to the default mobile phone number or another registered mobile phone number. Optionally, the user can enter a new mobile phone number without authorizing the new number.

Once the user has initiated the virtual card activation, a virtual card number is generated and sent to the user via SMS.

The virtual card on the mobile phone can be used for any kind of transaction at an online merchant as long as the payment doesn't exceed the amount activated or topped up on the card.

Mobile Phone-Based Scenario

To activate a virtual card from the mobile phone the user has to call a dedicated number from anywhere he/she has mobile network coverage. After calling the number the user has to identify and to authenticate using voice authentication.

For identification the user's MS-ISDN is checked. It's compared to the existing database and the user is identified. Optionally, the user has to enter a user-ID or user code using DTMF or voice recognition.

Once the user is identified, he/she has to follow a challenge/response procedure for authentication. The system will provide certain numbers which the user has to repeat to get authenticated. Optionally, the user has to enter a shared secret via DTMF for a first authentication step.

After successful voice authentication, the user is provided most of the options as in the web-based activation scenario. The user has to type in the desired amount he/she wants to activate the virtual card with using DTMF and confirm this amount. Optionally, the user can choose the amount from a list of available amounts using DTMF or voice recognition.

Once the user has initiated the virtual card activation, a virtual card number is generated and sent to the user via SMS.

Text messages comprising the SMS format are, in a currently preferred embodiment of the system, suitable means for initiating payment procedures and for topping-up the virtual prepaid card or even physical prepaid cards. For processing the SMS messages the central server of the system, herein also designated as authorizing system server, comprises an SMS gateway as a message interface. It is to be noted that besides the well-established SMS transmission in mobile networks meanwhile the transmission of similar messages in fixed-line networks is technically possible and well-established, so that the gateway may also be adapted as an interface to fixed-line telecommunication networks.

It makes sense that in the proposed system several standard types of SMS or components (templates) therefore are predetermined, which will be used for initiating predetermined procedures (activating a card, topping-up payment instructions). Such standard types may, after receipt at the server gateway, be processed into control data sets for triggering several electronic transactions in the payment server, with relatively low processing load and, therefore, very quickly.

An essential safety feature of the proposed process and system, in a preferred embodiment, is provided in that an authentication step is carried out in the framework of a call-back to the sender of a transaction order. The call-back can be made on the same channel on which a message initiating the transaction has been transmitted (i.e. in case of a mobile SMS via the same mobile network). However, in special cases intentionally a different channel (e.g. a fixed-line network or a data network connection) can be selected. For authenticating the sender of the transaction order the authentication mechanisms mentioned further above, or even other well-known authentication mechanisms, are used. It is useful to present, during the above-mentioned call-back, a user-friendly user menu to collect the required data.

Furthermore, for the sake of a system operation which is likewise smooth and aimed at a high user acceptance it is important to send suitable confirmation messages (preferably also via SMS), be it to the initiator of a prepaid card topping-up or to the initiator, as well as to the recipient, of an electronic payment.

Embodiments of the invention are not restricted to the above described examples and emphasized aspects but may also be formed with a variety of modifications which are within the scope of one of ordinary skill in the art.

1. Virtual prepaid or credit card, comprising a data set, free of a physical substrate, the data set being located in a memory of a transmitter or receiver and adapted to authorize a person who is in possession thereof to pay for a product or service, conduct an online transaction, or to obtain cash, the data set being obtainable in response to a user enrollment procedure and useable as a credit card or a pre-payment account, and being available at the receiver which comprises a telecommunication terminal of an enrolled holder for display and transmission.

2. Virtual prepaid or credit card according to claim 1, wherein the data set defining the card includes a set of data defining a limit for disposal, the latter set of data being settable by a control signal sent to the telecommunication terminal.

3. Virtual prepaid or credit card according to claim 1, wherein a unique terminal-ID of the telecommunication terminal is part of the data set defining the virtual prepaid or credit card.

4. Virtual prepaid or credit card according to claim 3, wherein the terminal-ID is a MS-ISDN of the mobile phone and defines a reception and transmission address of all messages regarding use of the card and originating from or being addressed to the holder of the card.

5. Virtual prepaid or credit card according to claim 1, wherein the data set defining the card comprises data which refer to an underlying enrollment procedure which includes an assessment of biometric features of the holder.

6. Process for providing a virtual prepaid or credit card, as a data set being adapted to authorize a person who is in possession thereof to pay for a product or service, conduct an online transaction, or to obtain cash, the process comprising: evaluating credit card account data or pre-payment data, to establish the data set, and a user enrollment procedure to form the data set, transmitting the data set to a telecommunication terminal of an enrolled holder via a mobile network or data transmission network.

7. Process according to claim 6, wherein the enrollment procedure further comprises evaluating biometric features of the holder including a voice profile.

8. Process according to claim 6, wherein data defining the method and/or a result of the enrollment procedure are introduced into the data set.

9. Process according to claim 6, further comprising detecting a unique terminal-ID ID of the telecommunication terminal of the holder and introducing the unique terminal ID into an authorizing data set.

10. Process for electronic payments using a virtual prepaid or credit card, comprising: sending payment instructions as electronic messages from a telecommunication terminal of the holder to a gateway of an authorization system server, checking the payment instructions by the server and, in response to a positive result of the checking, processing the instructions for controlling a payment procedure, and after the processing, transmitting electronic confirmation messages to a payee predetermined by the holder.

11. Process according to claim 10, further comprising carrying out the transmission an electronic message to a data or telecommunication terminal of the payee.

12. Process according to claim 10, further comprising the checking in the authorization system server including checking a disposal limit data set, which is generated in response to a pre-payment on a system-internal account by the holder in a payment server, including checking for existence of a disposal limit and, if present, comparing the existing disposal limit with a payment amount specified by the holder.

13. Process according to claim 10, wherein the checking in the authorization system server further comprises authenticating the sender of the payment instruction, including detecting and conducting a current comparison of biometric features with biometric features stored during an enrollment procedure.

14. Process according to claim 13, wherein for detecting the biometric features, in response to reception of an electronic message by the authorization system server, making a call-back to the sending telecommunication terminal and carrying out an output of a user menu via the terminal or mobile phone.

15. Process according to claim 14, further comprising for detecting a current voice profile in the framework of the user menu on the telecommunication terminal, the user speaking numbers, text parts or other verbal responses that are displayed and the spoken numbers, text parts or other verbal responses are acoustically detected, and evaluating a current voice profile at the authorization system server therefrom.

16. Process according to claim 10, further comprising the processing of a payment instruction in the authorization system server including transmitting payment control data sent to a payment server for controlling an electronic transfer of a payment amount specified in a message to a system-internal account or system-external account of the payee, the account being specified in the message or being stored in association to the payee.

17. Process according to claim 10, further comprising for topping-up the prepaid card with a predetermined amount, transmitting an electronic message from the telecommunication terminal of the holder to a gateway of the authorization system server and checking and processing the received message in the server, and in response to a positive result of the checking, transmitting a topping-up control data set to a payment server, whereby the topping-up amount is transferred to the system-internal account of the cardholder.

18. Process according to claim 10, wherein the electronic message being sent from the holder and/or the electronic message being forwarded to the specified payee comprises an SMS format.

19. Process according to claim 18, further comprising generating the electronic message in the SMS format out using system-internally generated templates, and processing of the received SMS messages in the authorization system server including a detection and comparison of templates contained therein.

20. System for providing a virtual prepaid or credit card, as a data set, free of a physical substrate, the data being adapted to authorize a person who is in possession thereof to pay for a product or service, conduct an online transaction, or to obtain cash, the data set being useable as a credit card account or a pre-payment account and in response to a user enrollment procedure, and being available at a telecommunication terminal, of the enrolled holder for display and transmission, the system comprising
a credit card account or payment server storing and processing credit card or pre-payment data of a user and system-internal electronic accounts, as well as way of payment data for electronic transactions from/to system-external accounts,
an authorization system server storing and processing user authentication data, including biometric data of the user,
credit card data set generation means being connected to both the credit card data server and authentication server for establishing the data set defining the virtual credit card or a way of payment, and
data set transmissions means for transmitting the card data set or payment data set via a telecommunications network or data transfer network, to a user terminal connected to the network or to the authorization system server.

21. System according to claim 20, wherein a system account data base is connected to the payment server, the data base comprising system accounts each of which is associated to an enrolled holder of a virtual prepaid or credit card.

22. System according to claim 21, wherein the system account data base comprises an electronic general account, to which the system accounts are connected by means of internal control signal lines.

23. System according to claim 20, wherein the data set transmission means is adapted as SMS gateway for transmitting the card data sets in an SMS format.

24. Arrangement for electronic payments, including a system, credit card account or payment server storing and processing credit card or pre-payment data of a user and system-internal electronic accounts, as well as payment data for electronic transactions from/to system-external accounts, an authorization system server storing and processing user authentication data, including biometric data of the user,
credit card data set generation means being connected to both the credit card data server and authentication server for establishing the data set defining the virtual credit card or a way of payment, and
data set transmissions means for transmitting the card data set or payment data set via a telecommunications network or a mobile network, to a user terminal connected to the network or to the authorization system server, wherein the authorization system server is adapted to check electronic messages being sent from the telecommunication terminals of card holders, for controlling a payment procedure and, if valid, for forwarding same, wherein the check includes a check of user authentication data and the processing includes the generation and transmission of control data sets for electronically transferring payment amounts at least one of toor from system accounts being managed by the payment server.
